(19) United States
(12) Patent Application Publication
(10) Pub. No.: US 2025/0212087 A1
(43) Pub. Date: Jun. 26, 2025

(54) METHOD OF FORWARDING PACKETS IN WI-FI NETWORK FOR REDUCING PACKET LOSS, AND PRIMARY NODE AND SECONDARY NODE UTILIZING THE SAME

(71) Applicant: Realtek Semiconductor Corp., HsinChu (TW)

(72) Inventors: ZHAOMING LI, Suzhou City (CN); Mengzhou Shen, Suzhou City (CN); Lei Chen, Suzhou City (CN)

(73) Assignee: Realtek Semiconductor Corp., HsinChu (TW)

(21) Appl. No.: 18/809,252

(22) Filed: Aug. 19, 2024

(30) Foreign Application Priority Data
Dec. 22, 2023 (CN) 202311785782.X
Apr. 16, 2024 (CN) 202410459271.7

(51) Int. Cl. H04W 40/04; H04L 45/655; H04W 40/16

(52) U.S. Cl. CPC H04W 40/04; H04L 45/655; H04W 40/16

(57) ABSTRACT

A Wi-Fi network includes a primary node and N secondary nodes, N being an integer greater than 1. A packet forwarding method of the Wi-Fi network includes the primary node transmitting M unicast packets to the N secondary nodes in sequence, M being a positive integer and M≥N, a forwarding secondary node in the N secondary nodes receiving the M unicast packets, the forwarding secondary node generating and transmitting a forwarding packet according to a unicast packet in the M unicast packets, and a target secondary node in the N secondary nodes receiving the forwarding packet.

### BACKGROUND OF THE INVENTION

### 1. Field of the Invention

The present invention relates to data transmission in Wi-Fi networks, and in particular, to a packet forwarding method for use in a Wi-Fi network of an audio system for reducing packet loss, as well as the parent node and the secondary nodes thereof.

### 2. Description of the Prior Art

Wi-Fi networks have permeated every aspect of daily life, playing a crucial role from smart homes to entertainment systems. As audio quality demands continue to rise, Wi-Fi has become the preferred connection method for products such as smart speakers owing to its high-speed and stable transmission capabilities. Wi-Fi smart speakers not only deliver high-quality music playback, but can also interact with other smart devices, bringing users more comprehensive experience. Therefore, Wi-Fi networks will play an even more significant role in upcoming smart devices.

Current audio and video systems usually support multiple channels, necessitating the use of multiple Wi-Fi smart speakers. In a typical setup, the primary node transmits audio data over Wi-Fi using multicast or broadcast. Subsequently, the secondary nodes receive and process the data from the respective channels before passing the data to the corresponding audio playback circuit for playback. Nevertheless, due to the lack of acknowledgment (ACK) messages for multicast or broadcast packets transmitted via Wi-Fi, there is no assurance that every secondary node will receive the audio data. If the secondary node fails to receive multiple consecutive packets, the secondary node cannot access the audio data carried in those packets, resulting in continuous loss of the audio data. When the loss of audio data surpasses a specific threshold, the playback would become discontinuous, adversely affecting the user's listening experience. Therefore, ensuring the stability and reliability of Wi-Fi smart speakers during audio data transmission is a critical issue in current technology research and development.

### SUMMARY OF THE INVENTION

According to an embodiment of the invention, a Wi-Fi network includes a primary node and N secondary nodes, N being an integer greater than 1. A packet forwarding method of the Wi-Fi network includes the primary node transmitting M unicast packets to the N secondary nodes in sequence, M being a positive integer and M≥N, a forwarding secondary node in the N secondary nodes receiving the M unicast packets, the forwarding secondary node generating and transmitting a forwarding packet according to a unicast packet in the M unicast packets, and a target secondary node in the N secondary nodes receiving the forwarding packet.

According to another embodiment of the invention, a secondary node includes a control module and a transceiver coupled to the control module. The transceiver is used to receive a unicast packet and a forwarding capability of the secondary node from a primary node. The control module is used to generate a forwarding packet according to the unicast packet, and enable the transceiver to transmit the forwarding packet according to at least the forwarding capability.

According to another embodiment of the invention, a primary node coupled to N secondary nodes is disclosed. The primary node includes a control module and a transceiver coupled to the control module. The transceiver is used to transmit M unicast packets to the N secondary nodes in sequence. The control module is used to determine M reception results of the M unicast packets, and determine the N forwarding capabilities of the N secondary nodes according to the M reception results of the M unicast packets, N being an integer greater than 1, M is a positive integer and M≥N. The transceiver is used to transmit the N forwarding capabilities of the N secondary nodes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a Wi-Fi network adopting space diversity according to an embodiment of the invention.

FIG. 2 is a flowchart of a packet forwarding method of the Wi-Fi network in FIG. 1.

FIG. 3 is a schematic diagram of transmitting unicast packets in sequence.

FIG. 4 is a schematic diagram of the Wi-Fi network adopting time diversity according to another embodiment of the invention.

FIG. 5 is a block diagram of a Wi-Fi network according to an embodiment of the invention.

FIG. 6 is a flowchart of an operation method of the primary node in FIG. 5.

FIG. 7 is a flowchart of an operation method of the secondary node in FIG. 5.

FIG. 8 is a flowchart of another operation method of the secondary node in FIG. 5.

### DETAILED DESCRIPTION

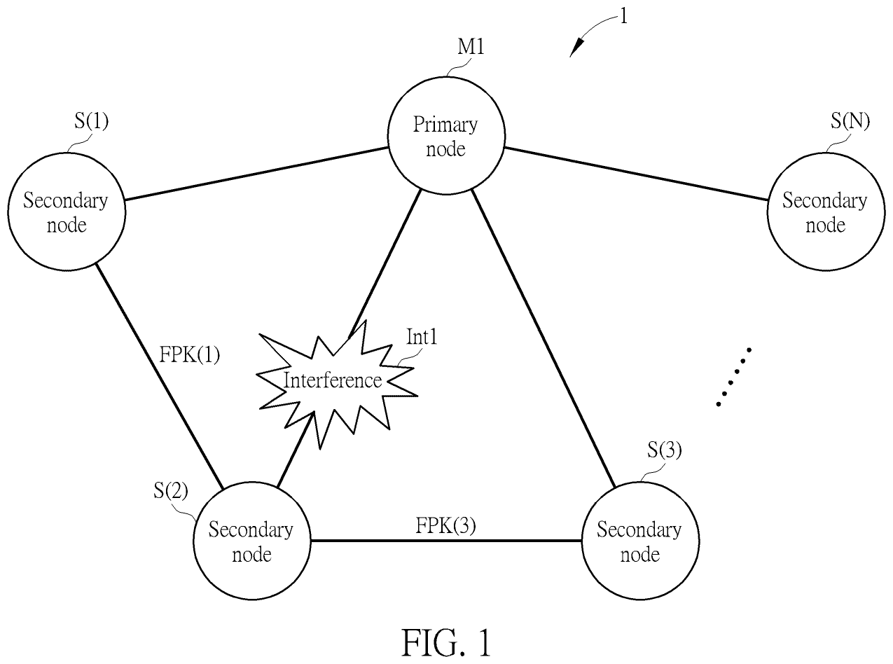

FIG. 1 is a schematic diagram of a Wi-Fi network 1 adopting space diversity according to an embodiment of the invention. The Wi-Fi network 1 may include a primary node M1 and secondary nodes S(1) to S(N), where the primary node M1 is coupled to the secondary nodes S(1) to S(N), and N is an integer greater than 1. For example, N=4, the Wi-Fi network 1 may include secondary nodes S(1) to S(4). The primary node M1 and the secondary nodes S(1) to S(N) may all have Wi-Fi transmission capabilities and transmit Wi-Fi packets to each other via Wi-Fi links. Given that the Wi-Fi network 1 operates in a time-varying environment, the Wi-Fi network 1 is susceptible to interference from nearby Wi-Fi networks, electronic appliances, moving individuals, metallic items, and other obstructions.

The Wi-Fi network 1 may be incorporated in audio systems, in which the primary node M1 may be a television, a computer, a set-top box, a multimedia player, or other source devices, and the secondary nodes S(1) to S(N) may be wireless speakers set at different spatial locations to support multi-channel playback. Each of the secondary nodes S(1) to S(N) may play back one or more channels of audio data. The primary node M1 may transmit Wi-Fi packets containing audio data of all channels in the unicast, multicast or broadcast mode. The secondary nodes S(1) to S(N) may receive and parse the Wi-Fi packets to obtain the audio data of the respective channel, and pass the audio data to the audio circuit in the secondary node for processing and playback. The Wi-Fi network 1 may address the issue where specific secondary nodes fail to accurately receive packets from the primary node M1 due to interference, by forwarding packets via uninterrupted secondary nodes, thereby effectively minimizing continuous packet loss at the secondary nodes, reducing the impact of interference-induced packet loss on network performance, and enhancing user experience.

If the interference Int1 occurs on the transmission path between the primary node M1 and the secondary node S(2), the secondary node S(2) may fail to receive the Wi-Fi packets sent from the primary node M1. However, since the spatial locations of the secondary nodes S(1), S(3) to S(N) are different from the secondary node S(2), there is no interference on the respective transmission paths. Therefore, the secondary nodes S(1), S(3) to S(N) may correctly receive the Wi-Fi packet from the primary node M1. Moreover, there is no interference in the transmission paths between the secondary nodes S(1), S(3) to S(N) and the secondary node S(2). Thus, one or more of secondary nodes S(1), S(3) to S(N) may retransmit the received Wi-Fi packets via the transmission path, increasing the likelihood of the secondary node S(2) receiving the forwarding packets and compensating for the previously lost Wi-Fi packets. In the embodiment, the secondary nodes S(1) and S(3) at different spatial locations may transmit the forwarding packets FPK(1) and FPK(3) according to the received Wi-Fi packet, enabling the secondary node S(2) to still receive the forwarding packet FPK(1) via the transmission path between the secondary nodes S(1) and S(2), and receive the forwarding packet FPK(3) via the transmission path between the secondary nodes S(3) and S(2), thereby achieving spatial diversity and increasing the reception success rate of the interfered secondary node.

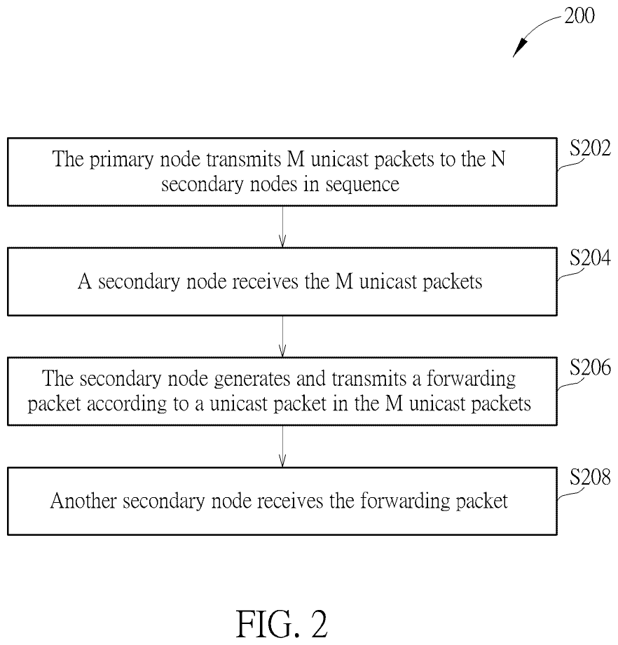

FIG. 2 is a flowchart of a packet forwarding method 200 of the Wi-Fi network 1. The method 200 includes Steps S202 to S208 for forwarding the packet to the secondary node affected by interference. Any reasonable step change or adjustment is within the scope of the disclosure. Steps S202 to S208 are detailed as follows:

Step S202: The primary node transmits M unicast packets to the N secondary nodes in sequence;

Step S204: A secondary node receives the M unicast packets;

Step S206: The secondary node generates and transmits a forwarding packet according to a unicast packet in the M unicast packets;

Step S208: Another secondary node receives the forwarding packet.

The Steps of the method 200 are now explained with reference to the Wi-Fi network 1. In Step S202, M is a positive integer and M≥N. In FIG. 1, M equals N, and the primary node M1 may transmit the unicast packets PK(1) to PK(N) containing the audio data of all channels to the secondary node S(1) to S(N) in sequence. In some embodiments, M may be greater than N, for example, M=6, N=3. The primary node M1 may sequentially transmit unicast packets PK(1) to PK(6), following the order of the secondary nodes S(1), S(1), S(2), S(2), S(3), and S(3).

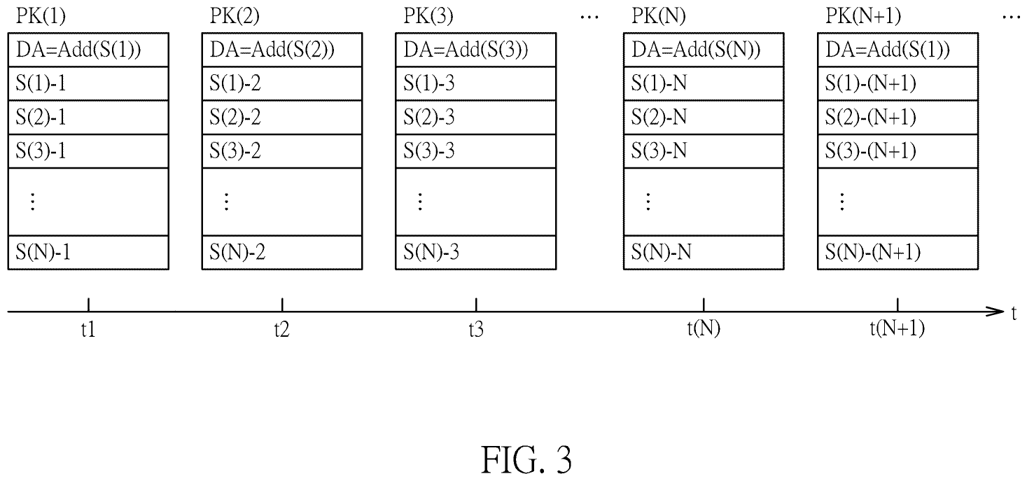

The unicast packets PK(1) to PK(N) carry multi-channel audio data of the secondary nodes S(1) to S(N) at various points in time. FIG. 3 is a schematic diagram of transmitting unicast packets in sequence, where the horizontal axis represents time t. At Time t1, the primary node M1 may transmit a unicast packet PK(1) to the secondary node S(1), the unicast packet PK(1) carrying the destination address DA and the audio data S(1)-1 to S(N)-1, where the target address DA may be the address Add (S(1)) of the secondary node S(1) (e.g., the media access control (MAC) address or the preset identifier), the audio data S(1)-1 may be the audio data of the secondary node S(1), . . . , and the audio data S(N)-1 may be the audio data of the secondary node S(N). If the secondary node S(1) successfully receives the unicast packet PK(1), the secondary node S(1) will respond an acknowledgment (ACK) message to the primary node M1, reporting that the reception status of the secondary node S(1) is good. Further, the secondary node S(1) will parse the unicast packet PK(1) to obtain the audio data S(1)-1, and process and play back the audio data S(1)-1 accordingly. If the secondary node S(1) fails to receive the unicast packet PK(1), the secondary node S(1) will not respond the acknowledgment (ACK) message to the primary node M1, thereby reporting the poor reception status of the secondary node S(1). In some embodiments, the primary node M1 is not limited to using the same unicast packet PK(1) to transmit the target address DA and the audio data S(1)-1 to S(N)-1, but may use separate packets to transmit the target address DA and the audio data S(1)-1 to S(N)-1 respectively. Simultaneously, the other secondary nodes S(2) to S(N) detect and receive the unicast packet PK(1) in sniffer mode. Since the addresses of the secondary nodes S(2) to S(N) do not match the target address in the unicast packet PK(1), the secondary nodes S(2) to S(N) will not return ACK messages. Instead, the secondary nodes S(2) to S(N) will parse the unicast packet PK(1) to obtain the audio data S(2)-1 to S(N)-1, process and play the respective data accordingly. Similarly, at Time t2, the primary node M1 may transmit a unicast packet PK(2) to the secondary node S(2), the unicast packet PK(2) carrying the target address DA and the audio data S(1)-2 to S(N)-2, where the target address DA may be the address Add (S(2)) of the secondary node S(2), the audio data S(1)-2 may be the audio data of the secondary node S(1), . . . , and the audio data S(N)-2 may be the audio data of the secondary node S(N). If the secondary node S(2) successfully receives the unicast packet PK(2), the secondary node S(2) will return an ACK message to the primary node M1, reporting that the reception status of the secondary node S(2) is good. Further, the secondary node S(2) will parse the unicast packet PK(2) to obtain the audio data S(2)-2, and process and play back the audio data S(2)-2 accordingly. If the secondary node S(2) fails to receive the unicast packet PK(2), the secondary node S(2) will not respond the ACK message to the primary node M1, thereby reporting the poor reception status of the secondary node S(2). Simultaneously, the other secondary nodes S(1), S(3) to S(N) detect and receive the unicast packet PK(2) in the sniff mode, parse the unicast packet PK(2) to obtain the audio data S(1)-2, S(3)-2 to S(N)-1 respectively, and process and play back the respective audio data accordingly. In this manner, at Time t3 to Time t (N), the primary node M1 may transmit the unicast packets PK(3) to PK(N) to the secondary nodes S(3) to S(N) in sequence. The other secondary nodes may receive unicast packets PK(3) to PK(N) in the sniff mode, so that the secondary nodes S(1) to S(N) may each obtain respective audio data. At Time t (N+1), the primary node M1 may transmit the unicast packet PK(N+1) to the secondary node S(1), so as to re-transmit the unicast packets according to the order of Time t1 to Time t (N) to start the next unicast cycle.

In Step S204, the secondary node S(n1) in the secondary nodes S(1) to S(N) is unaffected by the interference and has good reception status from Time t1 to Time t (N), enabling the secondary node S(n1) to receive the unicast packets PK(1) to PK(N) and obtain all the audio data in the unicast packets PK(1) to PK(N), where n1 is an integer ranging from 1 to N. For example, n1 may be 1 or 3, and the secondary node S(1) and/or S(3) may serve as forwarding secondary nodes. In Step S206, the secondary node S(n1) generates and transmits one or more forwarding packets according to one or more of the unicast packets PK(1) to PK(N), and transmits the forwarding packets via an interference-free transmission path to the affected secondary node. In some embodiments, the secondary node S(n1) may directly generate and transmit one or more forwarding packets by unicast, multicast or broadcast according to all audio data in the unicast packets PK(1) to PK(N). For example, the secondary node S(1) may generate and transmit a forwarding packet FPK(1) directly according to all the audio data S(1)-1 to S(N)-1 in the unicast packet PK(1), and/or the secondary node S(3) may generate and transmit a forwarding packet FPK(3) directly according to all the audio data S(1)-1 to S(N)-1 in the unicast packet PK(1). In other embodiments, the secondary node S(n1) may generate and transmit one or more forwarding packets respectively according to a portion of the audio data in the unicast packets PK(1) to PK(N), thereby reducing the size of the forwarding packets and accelerating the forwarding speed. For example, the secondary node S(1) may generate and transmit a forward packet FPK(1) according only to the audio data S(2)-1 in the unicast packet PK(1), and/or the secondary node S(3) may generate and transmit a forwarding packet FPK(3) according only to the audio data S(2)-1 in the unicast packet PK(1). In Step S208, another secondary node S(n2) in the secondary nodes S(1) to S(N) may be affected by the interference, n2 is an integer ranging from 1 to N and n2 is not equal to n1. For example, n2 may be 2, and the secondary node S(2) may serve as a target secondary node that is affected by the interference Int1 and fails to receive one or more of the unicast packets PK(1) to PK(N). The secondary node S(2) receives the forwarding packet FPK(1) via the transmission path between the secondary nodes S(1) and S(2), and/or receives the forwarding packet FPK(3) via the transmission path between the secondary nodes S(3) and S(2), thereby adopting spatial diversity forwarding process to compensate for the audio data previously lost due to interference.

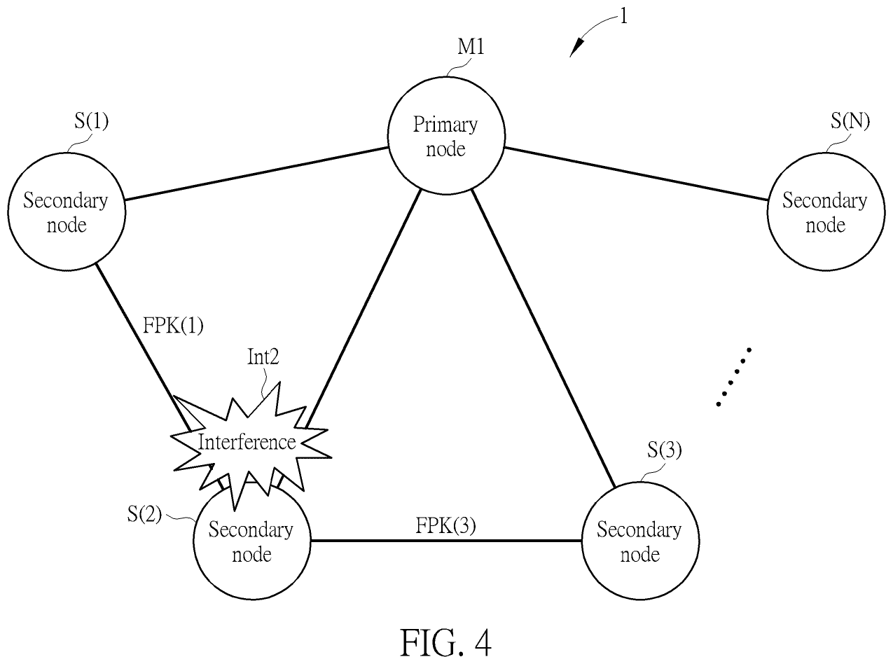

In some embodiments, the Wi-Fi network 1 may further adopt a time diversity forwarding process. FIG. 4 is a schematic diagram of the Wi-Fi network 1 adopting time diversity according to an embodiment of the invention. The difference between FIG. 4 and FIG. 1 lies in the interference Int2 present near the secondary node S(2), which simultaneously impacts the transmission path between the primary node M1 and the secondary node S(2), as well as the transmission path between the secondary nodes S(1) and S(2). As there is no interference on the transmission paths between the secondary nodes S(1), S(3) to S(N) and the primary node M1, the secondary nodes S(1), S(3) to S(N) may successfully receive the packets transmitted by the primary node M1. If the secondary node S(1) immediately forwards the packet upon receiving the packet from the primary node M1, the ongoing interference Int2 on the transmission path between the secondary nodes S(1) and S(2) may prevent the secondary node S(2) from receiving the forwarding packet. If the interference Int2 is sudden and brief, the secondary nodes S(1) and/or S(3) may evade the interference Int2 by forwarding at later times, thereby achieving time diversity and compensating for the data loss due to the interference. The secondary node S(1) may transmit the forwarding packet FPK(1) once the first delay time following the generation of the forwarding packet FPK(1) has elapsed. Similarly, the secondary node S(3) may transmit the forwarding packet FPK(3) once the second delay time following the generation of the forwarding packet FPK(3) has elapsed. the lengths of the first delay time and the second delay time being different. Setting different delay times for different secondary nodes forwarding may be an effective strategy to deal with burst interferences persisting for different durations. For example, if the interference Int2 persists for 1.5 milliseconds (ms) after the primary node M1 transmits the packet, with the first delay time being 1 ms and the second delay time being 2 ms, while the secondary node S(1) may not correctly receive the forwarding packet FPK(1), but the secondary node S(1) may potentially avoid the interference duration of the interference Int2 and correctly receive the forwarding packet FPK(3), thereby compensating for the previously lost audio data due to interference. Since each of the secondary nodes S(1) to S(N) incorporates an input buffer and/or a playback buffer, which are designed to store the received audio data and the audio data to be played respectively, the audio data remains valid as long as the sequence number of the newly received audio data/audio data to be played is within the buffer range of the input buffer and/or the playback buffer. Therefore, the packets that are delayed and forwarded by the secondary nodes S(1) and/or S(3) will still be processed as valid data as long as they fall within the buffer range of the secondary node S(2). In practical applications, the maximum delay time of the secondary nodes may be determined according to the sizes of the input buffer and/or the playback buffer.

The embodiments in FIGS. 1 to 4 utilize space diversity or time diversity to facilitate packet forwarding by secondary nodes, thereby reducing continuous packet loss in the interference environments, minimizing audio interruptions during playback, enhancing the reliability of audio data transmission, and enhancing user experience.

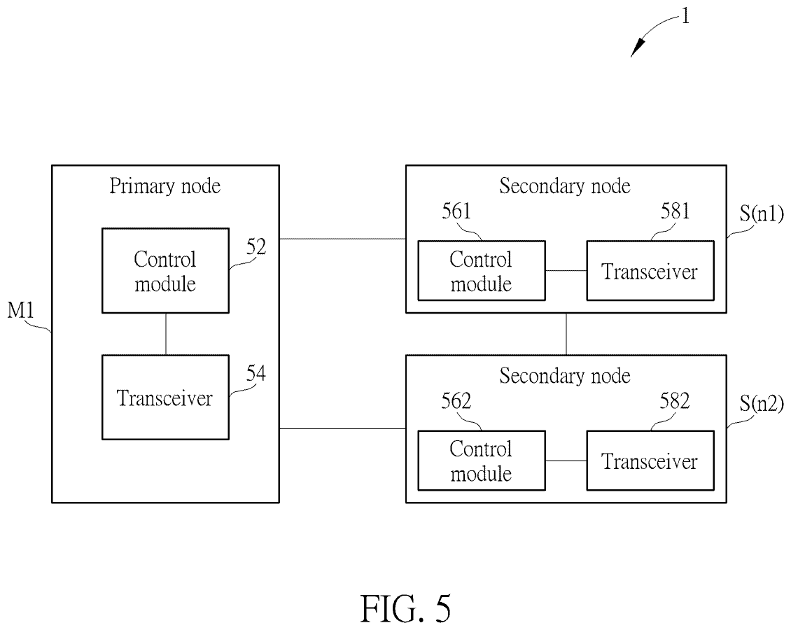

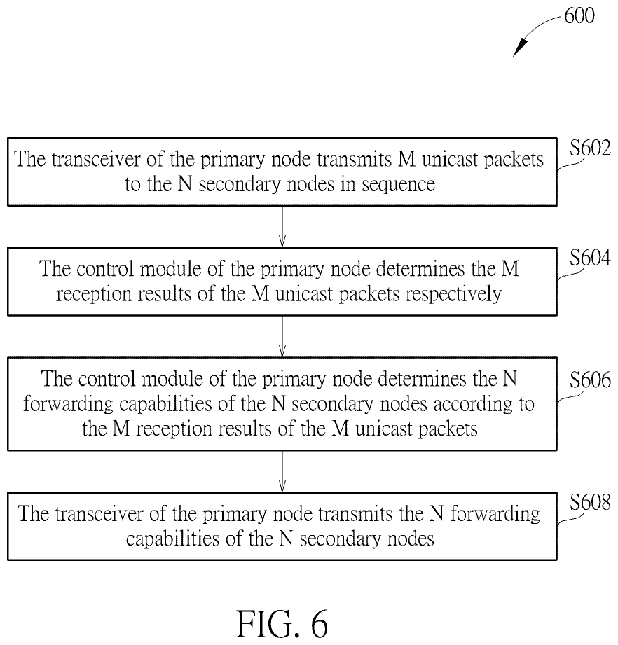

FIG. 5 is a block diagram of the primary node M1 and the secondary nodes S(n1) and S(n2) of the Wi-Fi network 1 in FIG. 1. One of the secondary nodes S(n1) and S(n2) may serve as a target secondary node, and the other may serve as a forwarding secondary node. For clarity in the following discussion, the secondary node S(n1) is designated as the forwarding secondary node, while the secondary node S(n2) is designated as the target secondary node. The primary node M1 may include a control module 52 and a transceiver 54 coupled to each other, the secondary node S(n1) may include a control module 561 and a transceiver 581 coupled to each other, and the secondary node S(n2) may include a control module 562 and a transceiver 582 coupled to each other. The control modules 52, 561, and 562 may be implemented by a combination of software, firmware, and hardware. Accordingly, the Wi-Fi network 1 may encompass the N secondary nodes, with the circuit configuration and operational mode of each secondary node similar to those of the secondary nodes S(n1) and/or S(n2). The primary node M1 may dynamically update and adjust the forwarding capability of each secondary node based on the reception status of each secondary node, as depicted in the operation method 600 in FIG. 6. FIG. 6 is a flowchart of an operation method 600 of the primary node M1. The method 600 includes Steps S602 to S608 for setting the forwarding capabilities of the N secondary nodes. Any reasonable step change or adjustment is within the scope of the disclosure. Steps S602 to S608 are detailed as follows:

Step S602: The transceiver of the primary node transmits M unicast packets to the N secondary nodes in sequence;

Step S604: The control module of the primary node determines the M reception results of the M unicast packets respectively;

Step S606: The control module of the primary node determines the N forwarding capabilities of the N secondary nodes according to the M reception results of the M unicast packets;

Step S608: The transceiver of the primary node transmits the N forwarding capabilities of the N secondary nodes.

In Step S602, the transceiver 54 of the primary node M1 may employ the unicast method as depicted in FIG. 3 to cyclically transmit unicast packets to the N secondary nodes. In Step S604, the control module 52 of the primary node M1 may determine the M reception results of the M unicast packets according to the receipt of ACK messages over the M unicast packets. If an ACK message of the m-th unicast packet is received during a predetermined reporting period, the control module 52 of the primary node M1 may determine that the reception result of the n-th secondary node is successful. Conversely, if the ACK message of the m-th unicast packet is not received during the predetermined reporting period, the control module 52 of the primary node M1 may determine that the reception result of the n-th secondary node is unsuccessful. Here, m is an integer ranging from 1 to M, and n is an integer ranging from 1 to N. The control module 52 of the primary node M1 may sequentially determine the M reception results of the M unicast packets.

In Step S606, the control module 52 of the primary node M1 counts the information (e.g., ACK messages) of the M reception results to determine the reception status of each secondary node, and assesses the forwarding capability of each secondary node according to the reception status thereof. Only secondary nodes exhibiting good reception statuses may possess forwarding capabilities. In some embodiments, the primary node M1 may count the ACK messages over a predetermined number of unicast packets to determine the reception status of each secondary node. For example, the predetermined number may be N, and the primary node M1 may count the ACK messages over M unicast packets to determine the reception statuses of the N secondary nodes. If the reception result of the n-th secondary node is successful, the control module 52 of the primary node M1 may determine that the reception status of the n-th secondary node is good. Conversely, if the reception result of the n-th secondary node is unsuccessful, the control module 52 of the primary node M1 may determine that the reception status of the n-th secondary node is poor. In other embodiments, the primary node M1 may count ACK messages for unicast packets within a predetermined period to determine the reception status of each secondary node. For example, the predetermined period may be 1 ms, and the control module 52 of the primary node M1 may count the ACK messages responded by the 1st to Nth secondary nodes in 1 ms to determine the reception statuses of the N secondary nodes. If the number of ACK messages of the n-th secondary node is greater than the ACK threshold (e.g., 3), the control module 52 of the primary node M1 may determine that the reception status of the n-th secondary node is good. Consequently, the control module 52 of the primary node M1 may enable the forwarding capability of the n-th secondary node, setting the n-th secondary node as a forwarding secondary node. If the number of ACK messages of the n-th secondary node is less than or equal to the ACK threshold, the control module 52 of the primary node M1 may determine that the reception status of the n-th secondary node is poor. Consequently, the control module 52 of the primary node M1 may disable the forwarding capability of the n-th secondary node, setting the nth secondary node as a non-forwarding secondary node. The control module 52 of the primary node M1 may sequentially determine the N forwarding capabilities of the N secondary nodes.

In Step S608, the transceiver 54 of the primary node M1 transmits the information (such as addresses) of all forwarding secondary nodes and non-forwarding secondary nodes to the N secondary nodes. The transceiver 54 of the primary node M1 may encapsulate the information of all forwarding and non-forwarding secondary nodes in unicast packets for transmission. Alternatively, the information of all forwarding and non-forwarding secondary nodes may be sent as a distinct packet in unicast, multicast, or broadcast mode, enabling the N secondary nodes to adjust their forwarding capabilities accordingly. The primary node M1 may dynamically update the information of the forwarding secondary nodes according to the real-time reception statuses of the N secondary nodes. The N secondary nodes may also dynamically alter their respective forwarding capabilities according to the packets they receive, thereby flexibly switching the forwarding secondary nodes in a dynamic interference environment to correspond to the interference on different paths.

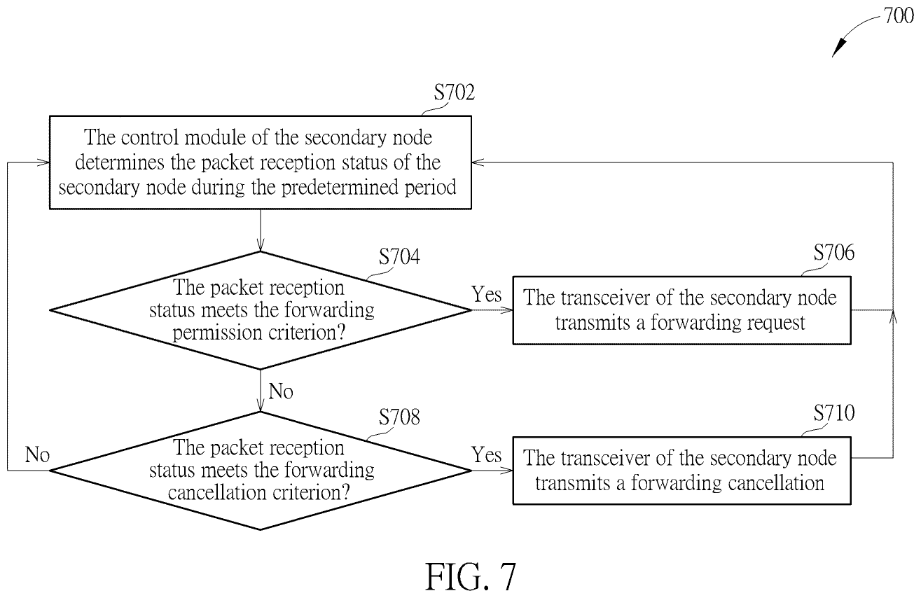

When the forwarding capability of a secondary node is set to on, the secondary node may forward packets according to all forwarding or selective forwarding. All forwarding may be that as long as the secondary node receives the unicast packet from the primary node M1, it will be forwarded through Wi-Fi transmission. Selective forwarding may forward when predetermined criteria are met instead of always forwarding. In some embodiments, selective forwarding may be enabled upon receipt of a forwarding request transmitted from the interfered secondary node S(n2) or from the primary node M1. The way in which the secondary node S(n2) controls the forwarding capability is as shown in FIG. 7. FIG. 7 is a flowchart of an operation method 700 of the secondary node S(n2) in FIG. 5. The method 700 includes Steps S702 to S710 for controlling the forwarding capability of the forwarding secondary node. Any reasonable step change or adjustment is within the scope of the disclosure. Steps S702 to S710 are detailed as follows:

Step S702: The control module of the secondary node determines the packet reception status of the secondary node during the predetermined period;

Step S704: The control module of the secondary node determines whether the packet reception status meets the forwarding permission criterion? if so, proceed to Step S706; if not, proceed to Step S708;

Step S706: The transceiver of the secondary node transmits a forwarding request; proceed to Step S702;

Step S708: The control module of the secondary node determines whether the packet reception status meets the forwarding cancellation criterion? if so, proceed to Step S710; if not, proceed to Step S702;

Step S710: The transceiver of the secondary node transmits a forwarding cancellation; proceed to Step S702.

In Step S702, the control module 562 of the secondary node S(n2) will continuously determine the packet reception status. The packet reception status may be represented by various means, including but not limited to the number of unicast packets received within a predetermined period or the consecutive changes in packet signal strength. In Step S704, if the packet reception status is represented by the number of unicast packets received in the predetermined period, the forwarding permission criterion may be triggered when the received unicast packets fall below a quantity threshold. For example, if the number of received unicast packets is 1 and the quantity threshold is set at 3, the packet reception status meets the forwarding permission criterion, suggesting that secondary node S(n2) may be experiencing interference. Consequently, the transceiver 582 of secondary node S(n2) issues a forwarding request (Step S706). If the packet reception status is represented by the consecutive changes in packet signal strength, the forwarding permission criterion may be triggered when the signal strengths of three consecutive packets decrease more than a change threshold. If the signal strength decline of three consecutive packets is greater than the change threshold, the packet reception status meets the forwarding permission criterion, suggesting that the secondary node S(n2) may be affected by interference, prompting the transceiver 582 of the secondary node S(n2) transmits a forwarding request. request (Step S706). The secondary node S(n2) then continues to determine the packet reception status thereof (S702). The specific content, format and length of the forwarding request may be determined by the application layer. Upon receiving the forwarding request, the other secondary nodes S(n1) having the forwarding capability will activate their forwarding capability.

In Step S708, after transmitting the forwarding request, if the secondary node S(2) determines that the number of received unicast packets is greater than or equal to the quantity threshold, or the signal strengths of the received packets returns to normal, the packet reception status satisfies the forwarding cancellation criterion, suggesting that the interference near the secondary node S(n2) has been removed or reduced. Consequently the transceiver 582 of the secondary node S(n2) transmits the forwarding cancellation (Step S710), and continues to determine the packet reception status thereof (S702). The specific content, format and length of forwarding cancellation may be determined by the application layer. When the other secondary node S(n1) having the forwarding capability receives the forwarding cancellation, the secondary node S(n1) will stop forwarding. The condition for stopping forwarding may vary. In the embodiment, forwarding may stop upon receipt of the forwarding cancellation. Alternatively, the secondary node S(n1) may continue forwarding for a predetermined number of packets or for a set period before actively ceasing forwarding.

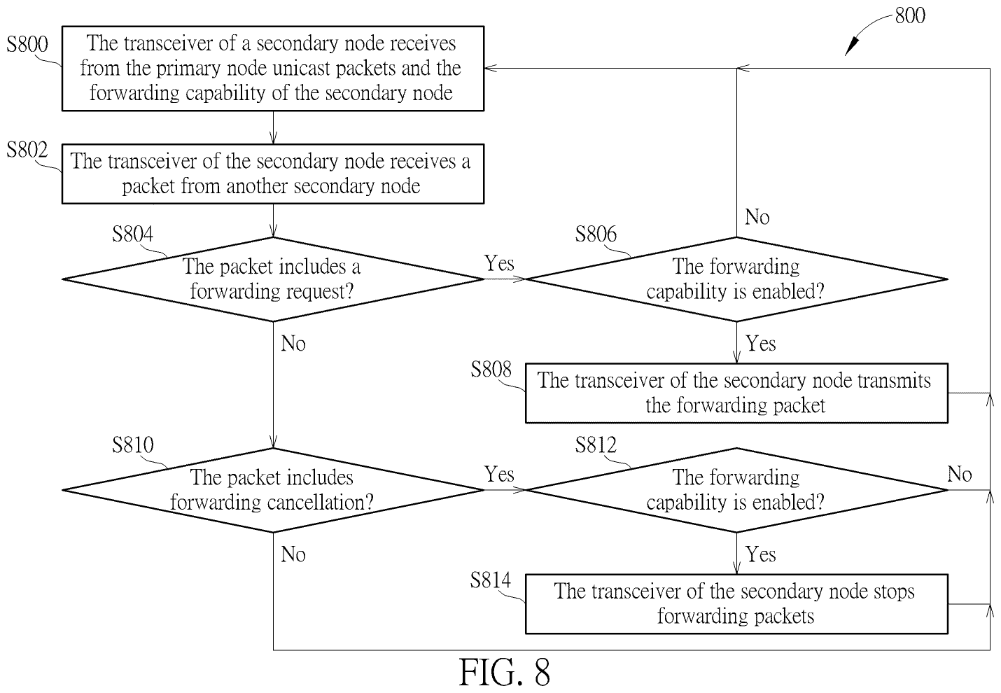

FIG. 8 is a flowchart of an operation method 800 of the forwarding secondary node S(n1) in FIG. 5. The method 800 includes Steps S800 to S814 for controlling the forwarding capability of the secondary node S(n1). Any reasonable step change or adjustment is within the scope of the disclosure. Steps S800 to S814 are detailed as follows:

Step S800: The transceiver of a secondary node receives from the primary node unicast packets and the forwarding capability of the secondary node;

Step S802: The transceiver of the secondary node receives a packet from another secondary node;

Step S804: The control module of the secondary node determines whether the packet includes a forwarding request? if so, proceed to Step S806; if not, proceed to Step S810;

Step S806: The control module of the secondary node determines whether the forwarding capability is enabled? if so, proceed to Step S808; if not, proceed to Step S800;

Step S808: The transceiver of the secondary node transmits the forwarding packet; proceed to Step S800;

Step S810: The control module of the secondary node determines whether the packet includes forwarding cancellation? if so, proceed to Step S812; if not, proceed to Step S800;

Step S812: The control module of the secondary node determines whether the forwarding capability is enabled? if so, proceed to Step S814; if not, proceed to Step S800;

Step S814: The transceiver of the secondary node stops forwarding packets; proceed to Step S800.

In Step S800, the transceiver 581 of the secondary node S(n1) receives the information of the forwarding secondary node and/or the non-forwarding secondary node from the primary node M1 to determine the forwarding capability of the secondary node S(n1). If the information of the forwarding secondary node matches the information of the secondary node S(n1), the control module 561 of the secondary node S(n1) will enable the forwarding capability of the secondary node S(n1). If not, the control module 561 of the secondary node S(n1) will disable the forwarding capability of the secondary node S(n1). For example, the transceiver 581 of the secondary node S(n1) may receive the forwarding information of the secondary node including the address Add (S(n1)) of the secondary node S(n1) from the primary node M1. If the addresses match, the control module 561 of the secondary node S(n1) may determine that the forwarding capability thereof is enabled. The following Steps will be discussed assuming the forwarding capability of the secondary node S(n1) is enabled.

In Step S802, the transceiver 581 of the secondary node S(n1) receives the packet from the secondary node S(n2), and in Step S804, the control module 561 of the secondary node S(n1) determines whether the packet includes a forwarding request. If a forwarding request is included, the control module 561 of the secondary node S(n1) continues to determine whether the forwarding capability of the secondary node S(n1) is enabled (Step S806). Since the forwarding capability of the secondary node S(n1) is enabled, the control module 561 of the secondary node S(n1) will enable the forwarding capability and transmit the forwarding packet via the transceiver 581 of the secondary node S(n1) (Step S808). The secondary node S(n1) then continues to detect new unicast packets and forwarding capabilities (Step S800) and forward the packets to the secondary nodes S(n2) (Step S802).

In Step S804, if the packet received from the secondary node S(n2) does not include a forwarding request, the control module 561 of the secondary node S(n1) next determines whether the packet received from the secondary node S(n2) includes a forwarding cancellation (Step S810). If forwarding cancellation is included, the control module 561 of the secondary node S(n1) next determines whether the forwarding capability of the secondary node S(n1) is enabled (Step S812). Since the forwarding capability of the secondary node S(n1) is enabled, the transceiver 581 of the secondary node S(n1) stops forwarding packets and continues to detect new unicast packets and forwarding capabilities (Step S800) and packets sent from the other secondary nodes S(n2) (Step S802).

Although methods 800 and 700 are illustrated using secondary nodes S(n1) and S(n2) respectively, this invention is not limited to this configuration. In some embodiments, the secondary nodes S(n1) and S(n2) may also adopt methods 700 and 800 respectively, that is, the secondary nodes S(n1) and S(n2) may serve as target secondary nodes or forwarding secondary nodes. Moreover, all N secondary nodes in the Wi-Fi network 1 may serve as target secondary nodes or forwarding secondary nodes. Forwarding may be performed by one or more secondary nodes, and the same forwarding packet may be forwarded once or multiple times by a single secondary node. The number of forwarding nodes, the number of forwarding times, and the Wi-Fi rate configured to forward packets may be calculated and selected according to the Wi-Fi throughput requirements of the audio data. For example, considering 24-bit, 48 kilohertz (kHz), 6-channel audio data, the amount of data required for playback per millisecond is 864 (=(48*24)/(8*6)) bytes, the Wi-Fi throughput of the Wi-Fi network 1 needs to reach 6.9 (=864*8*1000/1000000) megabits per second (Mbps). Using a single data packet length of 1500 bytes as an example, the time interval for the primary node M1 to transmit consecutive unicast packets is 1500*8/6.9=1736 us. For ease of calculation, assuming that the primary node M1 and the secondary node S(n1) both transmit at the Wi-Fi rate of 54 Mbps. Since each transmission of a forwarding packet requires a channel contention time to compete for the channel in advance, if the channel contention time is 130 us, the time required for the transmission of a single forwarding packet is 352 us (=130+1500*8/54). Therefore, a single forwarding packet may be forwarded repeatedly for 4.9 times (1736/352). Each time the primary node M1 transmits a unicast packet, there are nearly 4 forwarding opportunities in total, and these 4 forwarding opportunities may be allocated to a single or multiple secondary nodes.

The Wi-Fi network and operation methods in FIGS. 1 to 8 are suitable for audio systems. The audio system controls the forwarding capability of each secondary node by cyclically transmitting unicast packets to multiple secondary nodes, and uses space diversity or time diversity to achieve the effect of forwarding packets by the secondary nodes, reducing continuous packet loss at secondary nodes in interference environments, reducing audio interruptions during playback, increasing the reliability of audio data transmission and enhancing user experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A packet forwarding method of a Wi-Fi network, the Wi-Fi network comprising a primary node and N secondary nodes, N being an integer greater than 1, the method comprising:
the primary node transmitting M unicast packets to the N secondary nodes in sequence, M being a positive integer and M≥N;
a forwarding secondary node in the N secondary nodes receiving the M unicast packets;
the forwarding secondary node generating and transmitting a forwarding packet according to a unicast packet in the M unicast packets; and
a target secondary node in the N secondary nodes receiving the forwarding packet.

2. The method of claim 1, wherein each unicast packet in the M unicast packets carries data of the N secondary nodes.

3. The method of claim 1, wherein the forwarding packet includes data of the target secondary node.

4. The method of claim 1, further comprising:
the primary node determining the M reception results of the M unicast packets respectively;
the primary node determining N forwarding capabilities of the N secondary nodes according to the M reception results of the N secondary nodes; and
the primary node transmitting the N forwarding capabilities of the N secondary nodes.

5. The method of claim 4, further comprising:
the target secondary node determining a packet reception status of the target secondary node in a predetermined period; and
if the packet reception status satisfies a forwarding permission criterion, the target secondary node transmitting a forwarding request.

6. The method of claim 5, further comprising:
the forwarding secondary node receiving N forwarding capabilities of the N secondary nodes, wherein the forwarding capability of the forwarding secondary node is enabled; and
the forwarding secondary node receiving the forwarding request;
wherein the forwarding secondary node generating and transmitting the forwarding packet according to the unicast packet in the M unicast packets comprises: upon receiving the forwarding request, the forwarding secondary node transmitting the forwarding packet.

7. The method of claim 5, further comprising:
another forwarding secondary node in the N secondary nodes receiving the N forwarding capabilities of the N secondary nodes, wherein the forwarding capability of the another forwarding secondary node is disabled;
the another forwarding secondary node receiving the forwarding request; and
upon receiving the forwarding request, the another forwarding secondary node refraining from transmitting the forwarding packet.

8. The method of claim 4, further comprising:
the target secondary node determining a packet reception status of the target secondary node in a predetermined period;
if the packet reception status satisfies a forwarding cancellation criterion, the target secondary node transmitting a forwarding cancellation; and
upon receiving the forwarding cancellation, the forwarding secondary node stopping forwarding other unicast packets.

9. The method of claim 1, wherein the forwarding secondary node generating and transmitting the forwarding packet according to the unicast packet in the M unicast packets comprises:
once a first delay time following the generation of the forwarding packet has elapsed, the forwarding secondary node transmitting the forwarding packet.

10. The method of claim 9, further comprising:
another forwarding secondary node in the N secondary nodes receiving the M unicast packets; and
the another forwarding secondary node generating another forwarding packet according to the unicast packet, once a second delay time following the generation of the another forwarding packet has elapsed, the another forwarding secondary node transmitting the another forwarding packet, wherein the first delay time and the second delay time are different in length.

11. A secondary node comprising:
a control module; and
a transceiver coupled to the control module, and configured to receive a unicast packet and a forwarding capability of the secondary node from a primary node;
wherein, the control module is configured to generate a forwarding packet according to the unicast packet; and
the control module is configured to enable the transceiver to transmit the forwarding packet according to at least the forwarding capability.

12. The secondary node of claim 11, wherein the unicast packet includes data of N secondary nodes, and the N secondary nodes include the secondary node.

13. The secondary node of claim 11, wherein:
a destination address field of the unicast packet contains an address of the secondary node; and
the transceiver is further configured to transmit a reception result of the unicast packet to the primary node.

14. The secondary node of claim 11, wherein:
the control module is further configured to determine a packet reception status of the target secondary node in a predetermined period; and
the transceiver is further configured to transmit a forwarding request if the packet reception status satisfies a forwarding permission criterion.

15. The secondary node of claim 11, wherein:
the control module is further configured to determine a packet reception status of the target secondary node in a predetermined period; and
the transceiver is further configured to transmit a forwarding cancellation if the packet reception status satisfies a forwarding cancellation criterion.

16. The secondary node of claim 11, wherein:
the control module is configured to enable the transceiver to transmit the forwarding packet if the forwarding capability of the secondary node is enabled.

17. The secondary node of claim 11, wherein:
the control module is configured to enable the transceiver to transmit the forwarding packet if a forwarding request from another secondary node is received and the forwarding capability of the secondary node is enabled.

18. The secondary node of claim 17, wherein the forwarding packet includes data of the other secondary node.

19. A primary node coupled to N secondary nodes, the primary node comprising:
a control module; and
a transceiver coupled to the control module, and configured to transmit M unicast packets to the N secondary nodes in sequence;
wherein, the control module configured to determine M reception results of the M unicast packets;
the control module is configured to determine the N forwarding capabilities of the N secondary nodes according to the M reception results of the M unicast packets;
the transceiver is configured to transmit the N forwarding capabilities of the N secondary nodes;
N is an integer greater than 1; and
M is a positive integer and M≥N.

20. The primary node of claim 19, wherein each unicast packet in the M unicast packets carries data of the N secondary nodes.
